(19) United States
(12) Patent Application Publication
(10) Pub. No.: US 2009/0052605 A1
(43) Pub. Date: Feb. 26, 2009

(54) HANDLING SYSTEM FOR IN-CORE DETECTOR THIMBLE TUBE OF REACTOR

(76) Inventors: Jae-Kyung Lee, Daejeon (KR); Byung-Hak Cho, Daejeon (KR); Joon-Young Park, Daejeon (KR); Seung-Hyun Byun, Daejeon (KR); Myung-Ju Shim, Busan (KR); Byung-Tae Rho, Busan (KR)

Correspondence Address: MORGAN & FINNEGAN, L.L.P., 3 WORLD FINANCIAL CENTER, NEW YORK, NY, 10281-2101, US

(21) Appl. No.: 12/176,053

(22) Filed: Jul. 18, 2008

(30) Foreign Application Priority Data
Jul. 19, 2007 (KR) 10-2007-0072356

(51) Int. Cl. G21C 17/108

(52) U.S. Cl. 376/254

(57) ABSTRACT

A handling system for an in-core detector thimble tube of a reactor is disclosed. The handling system serves to withdraw and retract a thimble tube so as to provide a movement path of a movable detector used to measure a neutron flux within a reactor. For this, the handling system basically includes a thimble tube withdrawing/retracting device, which grips the thimble tube using a plurality of synthetic resin pinch rollers to withdraw and retract the thimble tube without any damage to the thimble tube, a thimble tube tensioning device, which applies a constant tensile force to the thimble tube to prevent the thimble tube from shaking or bending upon withdrawing/retracting operations, and a thimble tube platform, which temporarily keeps the withdrawn thimble tube at a fixed position without a risk of shaking of the thimble tube and provides a movement path of the thimble tube tensioning device. With automatic withdrawal/retraction of the thimble tube without damage provides advantages of an extended thimble tube exchange interval, improved safety of system facilities, reduced labor costs and working time, and reduced worker radiation exposure, shortened precaution/maintenance period, and enhanced reactor use efficiency.

### BACKGROUND OF THE INVENTION

1. Field of the Invention

The present invention relates to a handling system for an in-core detector thimble tube of a reactor, and more particularly, to a handling system for an in-core detector thimble tube of a reactor, which can automatically withdraw or retract the in-core detector thimble tube without any damage to the thimble tube, thereby achieving several advantages including an extended thimble tube exchange interval, improved safety of system facilities, reduced labor costs and working time, and reduced worker radiation exposure, shortened precaution/maintenance period, and enhanced reactor use efficiency.

The present invention provides a system capable of gripping, withdrawing and retracting an in-core detector thimble tube of a reactor for the purpose of automatic guidance of the thimble tube, and belongs to a mechanical appliance design in the field of mechatronics.

2. Description of the Related Art

A nuclear measurement system for use in a reactor is devised to measure distribution of a neutron flux within a pressurized light weight reactor. For this, the nuclear measurement system employs a movable in-core detector adapted to vertically move along a designated thimble tube within the reactor. The obtained information is utilized in the confirmation of reactor core design parameters.

Throughout the world, approximately one-hundred seventy nuclear power plants are installed with in-core nuclear detecting facilities using a movable detector. However, no nuclear power plants have a system to withdraw and retract a thimble tube using automated facilities. Currently, the withdrawal/retraction of the thimble tube simply depends on the worker's handling ability. Despite the fact that the thimble tube is an important component in terms of safety, serving to maintain a pressure boundary of a reactor coolant system, technology related to the withdrawal/retraction of the thimble tube is far behind and depends only on the worker's ability. Furthermore, thimble tube withdrawing/retracting operations are generally performed in a high radiation area located within a reactor pressure vessel and therefore, the worker is exposed to excessive radiation.

In addition, during the thimble tube withdrawal/retraction operations, maintaining a constant vertical grip force is actually difficult due to poor working environment. Therefore, a specific portion of the thimble tube, to which the worker's grip force is applied, is inevitably bent and the bent portion of the thimble tube is again spread upon retraction. With repeated bending and spreading operations, the thimble tube has a high risk of breakage.

### SUMMARY OF THE INVENTION

Therefore, the present invention has been made in view of the above problems, and it is an object of the present invention to provide a handling system for an in-core detector thimble tube of a reactor, which can automatically withdraw or retract the in-core detector thimble tube without any damage to the thimble tube, thereby achieving several advantages including an extended thimble tube exchange interval, improved safety of system facilities, reduced labor costs and working time, and reduced worker radiation exposure, shortened precaution/maintenance period, and enhanced reactor use efficiency.

In accordance with the present invention, the above and other objects can be accomplished by the provision of a handling system for an in-core detector thimble tube of a reactor, which provides a movement path of a movable detector used to measure a neutron flux within the reactor, the handling system comprising: a withdrawing/retracting device to grip the thimble tube using synthetic resin pinch rollers so as to withdraw and retract the thimble tube without any damage to the thimble tube; a thimble tube tensioning device to apply a constant tensile force to the thimble tube so as to prevent the thimble tube from shaking or bending upon withdrawing/retracting operations of the thimble tube; and a platform to temporarily keep the withdrawn thimble tube at a fixed position, to prevent shaking of the thimble tube, and to provide a movement path of the thimble tube tensioning device. The handling system can stably manage the thimble tube that is an important component in terms of safety, serving to maintain a pressure boundary of a reactor coolant system.

The withdrawing/retracting device may include: a body frame; a seal table disposed below the body frame and used to support the withdrawing/retracting device mounted thereon; a T-shaped clamp to mount the withdrawing/retracting device on the seal table; two upper and lower driving compression pinch rollers to be driven by two motors for increasing a thimble tube withdrawing/retracting force; two upper and lower idle compression pinch rollers to be driven by rotation of the driving compression pinch rollers; and a thimble tube clamping mechanism to grip the thimble tube in a roller compression manner via operation as screw nuts having clockwise and counterclockwise threads are tightened by a manually operable rotating handle. Automatic withdrawal/retraction of the thimble tube is possible, providing several advantages including reduced labor costs and working time, reduced worker radiation exposure, shortened precaution/maintenance period, and enhanced reactor use efficiency.

The handling system may further comprise: encoders provided, respectively, above the drive compression pinch rollers and the idle compression pinch rollers and used to measure an accurate withdrawn/retracted distance of the thimble tube, resulting in an improvement in the stability of system facilities.

The handling system may further comprise: an O-ring clamp to prevent introduction of impurities during thimble tube withdrawing/retracting operations and simultaneously, to achieve low-pressure sealing for maintaining a pressure boundary of the reactor, resulting in an improvement in the safety of the reactor via stable management of the thimble tube.

The thimble tube tensioning device may perform transmission of the tensile force to the thimble tube via torque control of a DC motor.

The thimble tube tensioning device may further include a tensioning device bridge to freely displace a position of the thimble tube tensioning device according to a coordinate of the thimble tube, whereby stable management of the thimble tube can be accomplished and also, safety of system facilities can be improved.

The handling system for an in-core detector thimble tube of a reactor according to the present invention can automatically withdraw or retract the in-core detector thimble tube without any damage to the thimble tube, thereby achieving several effects, such as for example, an extended thimble tube exchange interval, improved safety of system facilities, reduced labor costs and working time, and reduced worker radiation exposure, shortened precaution/maintenance period, and enhanced reactor use efficiency.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating the overall configuration of a handling system for an in-core detector thimble tube of a reactor according to the present invention;

FIGS. 2A to 2C are views illustrating a withdrawing/retracting device provided in the handling system for an in-core detector thimble tube of a reactor according to the present invention;

FIG. 3 is a sectional view illustrating the important part of an O-ring clamp according to the present invention;

FIG. 4 is a sectional view illustrating the important part of a thimble tube tensioning device according to the present invention;

FIG. 5 is a view illustrating a state wherein thimble tubes are mounted on a seal table according to the present invention;

FIG. 6 is a view illustrating the thimble tubes withdrawn from the seal table according to the present invention; and

FIG. 7 is a configuration view illustrating a thimble tube platform according to the present invention.

### DETAILED DESCRIPTION OF THE PREFERRED EMBODIMENTS

The present invention relates to a thimble tube withdrawing/retracting system for withdrawing and retracting a thimble tube, which provides a movement path of a movable detector used to measure a neutron flux within a pressurized light water reactor. Now, the overall configuration of the system will be described.

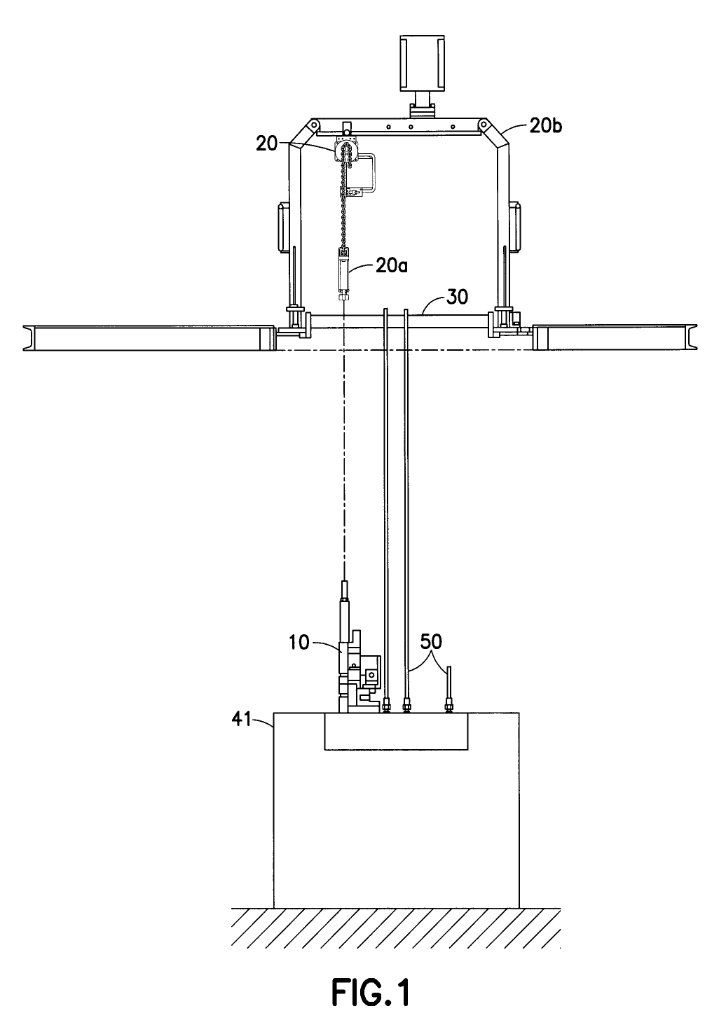

Referring to FIG. 1, the overall system broadly includes a thimble tube withdrawing/retracting device 10, a thimble tube tensioning device 20, and a thimble tube platform 30. The thimble tube withdrawing/retracting device 10 is used to grip each thimble tube 50 on a seal table 41, so as to withdraw and retract the thimble tube 50. The thimble tube tensioning device 20 is used to apply a tensile force to a distal end of the thimble tube 50, so as to prevent the thimble tube 50 from shaking upon withdrawing/retracting operations. The thimble tube platform 30 is used to stably dispose the withdrawn thimble tube 50 thereon. Here, the thimble tube tensioning device 20 has a bridge 20b to freely displace a position of the thimble tube tensioning device 20 according to a coordinate of the thimble tube 50.

More specifically, the present invention provides a handling system for an in-core detector thimble tube of a reactor, which serves to withdraw and retract the thimble tube 50 so as to provide a movement path of a movable detector used to measure a neutron flux within a reactor. For this, the handling system for an in-core detector thimble tube of a reactor basically includes the thimble tube withdrawing/retracting device 10, which grips the thimble tube 50 using a plurality of synthetic resin pinch rollers to withdraw and retract the thimble tube 50 without any damage to the thimble tube 50, the thimble tube tensioning device 20, which applies a constant tensile force to the thimble tube 50 to prevent the thimble tube 50 from shaking or bending upon withdrawing/retracting operations, and the thimble tube platform 30, which temporarily keeps the withdrawn thimble tube 50 at a fixed position without a risk of shaking of the thimble tube 50 and provides a movement path of the thimble tube tensioning device 20. The above-described basic configurations will be described hereinafter in more detail.

Now, details of the present invention will be described with reference to the above basic configurations as shown in FIG. 1.

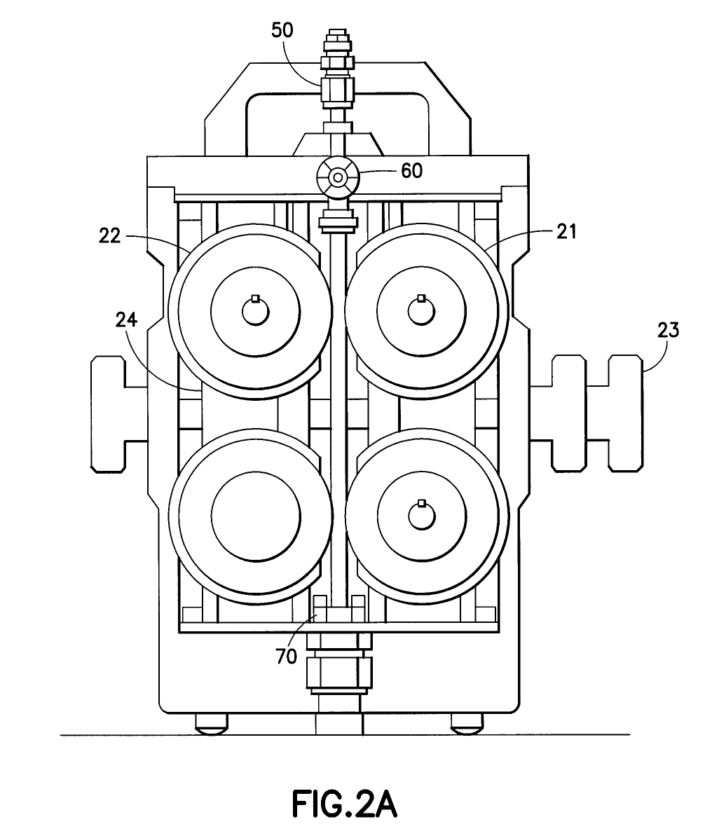

FIGS. 2A to 2C are, respectively, a front view, a side view and a plan view illustrating the thimble tube withdrawing/retracting device 10.

The thimble tube withdrawing/retracting device 10 includes two types of pinch rollers driven by DC motors. More particularly, the thimble tube withdrawing/retracting device 10 includes a body frame, a T-shaped clamp 40 used to mount the withdrawing/retracting device 10 on the seal table 41, a roller-compression type thimble tube clamping mechanism used to grip the thimble tube 50, driving compression pinch rollers 21 driven by motors, idle compression pinch rollers 22 provided with an encoder to measure an actual withdrawn/retracted distance of the thimble tube 50, etc.

During withdrawing/retracting operations of the thimble tube 50, the thimble tube 50 is first clamped by the driving compression pinch rollers 21 and the idle compression pinch rollers 22 as the pinch rollers 21 and 22 are manually compressed in a screw manner by use of a manually operable rotating handle 23. Here, the manually operable rotating handle 23 functions to adjust compression of the pinch rollers 21 and 22. These pinch rollers 20 and 21 are made of synthetic resin materials so as not to cause any damage to the thimble tube 50. The constituent materials of the pinch rollers 20 and 21 are experimentally determined by implementing thimble tube withdrawing/retracting tests at different velocities under dry and wet environments. In the present invention, to compensate for a low coefficient of friction during operation in a wet environment, the driving compression pinch rollers 21 are driven by two drive motors, respectively, so as to achieve an enhanced withdrawing/retracting force of the thimble tube 50. To measure the withdrawn/retracted distance of the thimble tube 50, two encoders 26 are provided. One of the encoders 26 is mounted to one of the drive motors 25 used to drive the driving compression pinch rollers 21, and the other encoder 26 is mounted to one of the idle compression pinch rollers 22. Due to a slip phenomenon inevitably occurring upon thimble tube withdrawing/retracting operations, it is necessary to mount the encoder 26 to the idle compression pinch roller 21 for measuring an accurate withdrawn/retracted distance of the thimble tube 50. With this configuration, the withdrawal/retraction of the thimble tube 50 can be precisely controlled on the basis of the slip phenomenon.

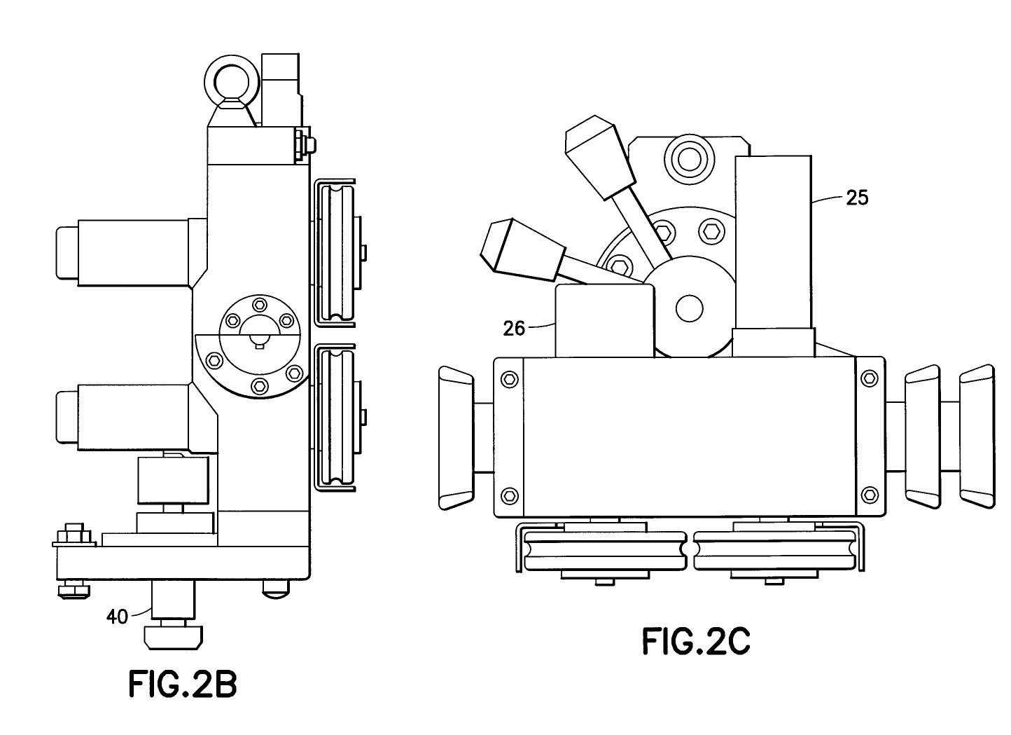

The thimble tube withdrawing/retracting device 10 is provided at the bottom thereof with the T-shaped clamp 40 (i.e. clamping shaft) such that the thimble tube withdrawing/retracting device 10 can be inserted into and fixed to the seal table 41 by means of the T-shaped clamp 40. In this case, to limit excessive insertion of the thimble tube withdrawing/retracting device 10, a proximity sensor 60 is provided. In addition, an O-ring clamp 70 is provided at a lower end of a thimble tube clamp 170. The O-ring clamp 70 serves not only to prevent introduction of impurities during thimble tube withdrawing/retracting operations, but also to achieve low-pressure sealing. Now, the configuration of the O-ring clamp 70 will be described with reference to FIG. 3.

As shown in FIG. 3, to install O-ring clamp 70, after the thimble tube 50 is manually withdrawn to approximately 400 mm via operation of a manual driving part of the withdrawing/retracting device 10, an O-ring 71 and a horseshoe-shaped plate 72 are inserted to the thimble tube 50. Then, after a fitting nut 73 is fixedly tightened by an appropriate force, the thimble tube 50 is automatically withdrawn by an automatic driving part of the withdrawing/retracting device 10 so as to be completely withdrawn from the seal table 41. Separation of the O-ring clamp 70 is performed after the thimble tube 50 is automatically retracted by the automatic driving part of the withdrawing/retracting device 10 and before the thimble tube 50 is manually retracted by the manual driving part of the withdrawing/retracting device 10.

Now, the withdrawing procedure of the thimble tube 50 by the withdrawing/retracting device 10 will be described in brief. First, after separating a shut-off valve stand from the thimble tube 50 protruding upward from the seal table 41, the withdrawing/retracting device 10 is positioned at a given coordinate of the thimble tube 50. Then, the withdrawing/retracting device 10 is fixedly fastened into a coupling hole of the seal table 41 by means of the T-shaped clamp 40. In such a fixed state of the withdrawing/retracting device 10, the manually operable rotating handle 23 of the withdrawing/retracting device 10 is operated, causing the driving compression pinch rollers 21 to compress the thimble tube 50 by means of screw nuts 24 having clockwise and counterclockwise threads. Thereafter, as the driving compression pinch rollers 21 are rotated by operation of the two upper and lower drive motors 25, the thimble tube 50 is vertically moved by friction. Then, a rotating force of the driving compression pinch rollers 21 rotated by the drive motors 25 is transmitted to the two idle compression pinch rollers 22, initiating rotation of the idle compression pinch rollers 22. With a control operation based on signals from the encoder 26 coupled to the upper one of the two idle compression pinch rollers 22 and the encoder 26 coupled to one of the drive motors 25, a withdrawing distance of the thimble tube 50 can be adjusted.

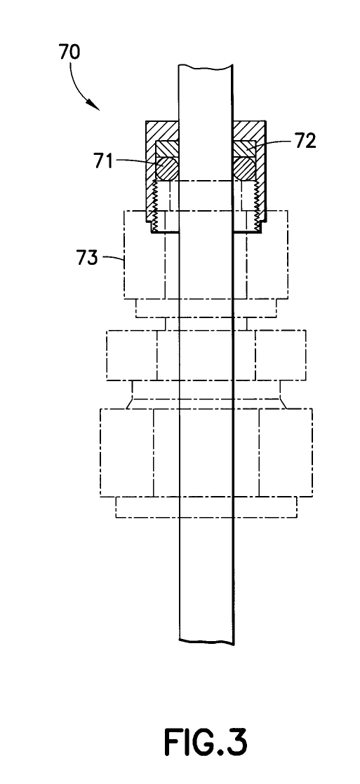

FIG. 4 is an exploded perspective view of the thimble tube tensioning device 20 shown in FIG. 1. Now, the thimble tube tensioning device 20 will be described in more detail with reference to FIG. 4. The thimble tube tensioning device 20 serves to provide a constant tensile force to the thimble tube 50 so as to prevent the thimble tube from shaking or bending upon withdrawing/retracting operations of the thimble tube 50 by the withdrawing/retracting device 10. The thimble tube tensioning device 20 includes a geared motor 110 provided with a brake, a chain sprocket 120, a flexible coupling 130, a housing 140, a link chain 150, a limit switch assembly 160, a thimble tube grip clamp 170, etc. The thimble tube tensioning device 20 is operated to transmit a constant tensile force to the thimble tube 50 under torque control of a DC motor (not shown). The limit switch assembly 160 is used to limit excessive withdrawing of the thimble tube 50. In operation, in a state wherein an upper end of the thimble tube 50 is caught by use of the thimble tube clamp 170, the chain sprocket 120 connected to the flexible coupling 130 is rotated upon receiving drive force of the DC motor (not shown) provided in the thimble tube tensioning device 20, thereby applying a constant tensile force to the upper part of the thimble tube 50. Then, the withdrawing/retracting device 10 is driven by the drive motors 25 so as to withdraw or retract the thimble tube 50.

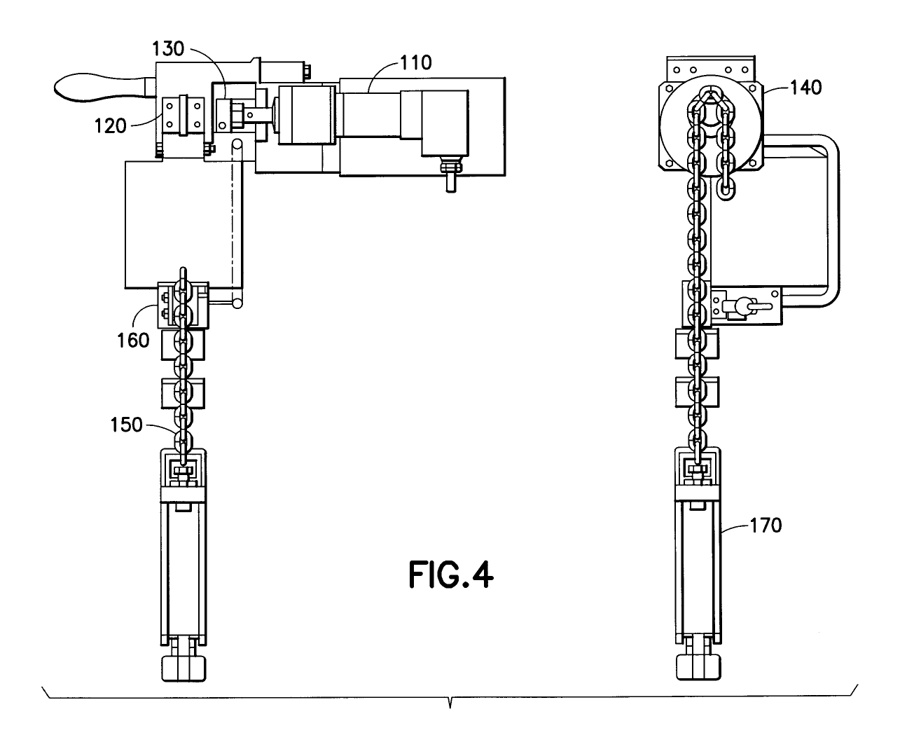

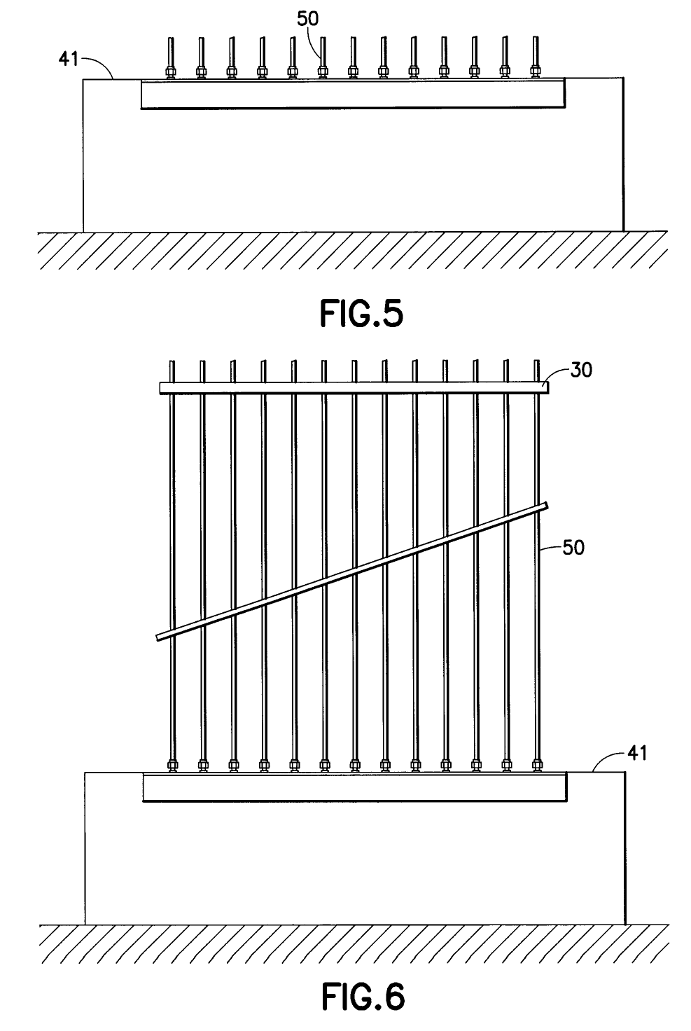

After the thimble tube 50 is completely withdrawn from the seal table 41 as shown in FIG. 5, the withdrawn thimble tube 50 is disposed on the thimble tube platform 30 as shown in FIG. 6.

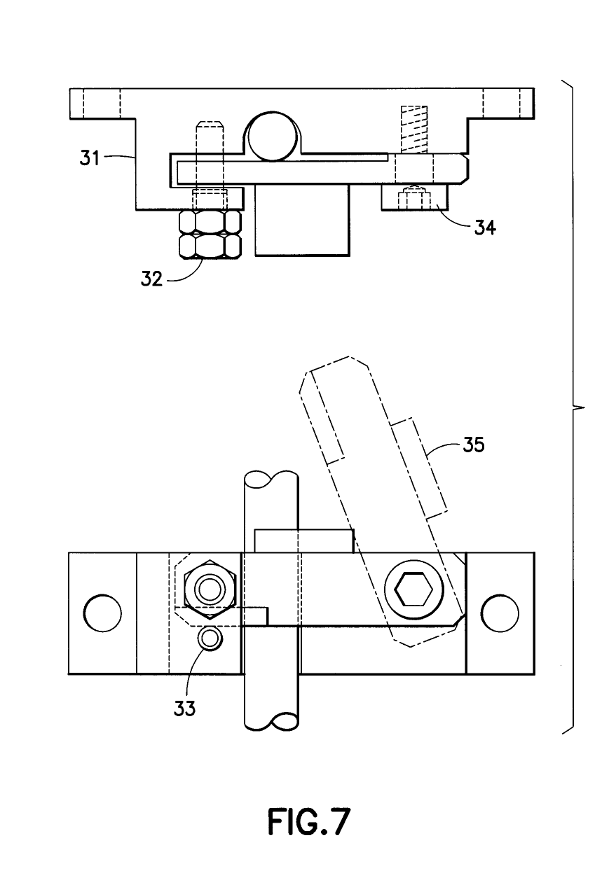

The thimble tube platform 30 is installed above the seal table 41 by means of supporting poles and bolts such that the thimble tube platform 30 is vertically spaced apart from the seal table 41 by a distance of approximately 5 meters. The thimble tube platform 30 is used to temporarily keep the withdrawn thimble tube 50 at a fixed position and also, to provide a movement path of the thimble tube tensioning device 20 for preventing shaking of the thimble tube 50 during thimble tube withdrawing/retracting operations. Now, the configuration of the thimble tube platform 30 will be described with reference to FIG. 7. The thimble tube platform 30 is a welded rectangular structure and has a size and shape suitable to stably dispose the thimble tube 50 withdrawn and separated from the seal table 41. For this, the thimble tube platform 30 is assembled with thimble tube holders, which have the same positions and pitch as all the thimble tubes 50 disposed on the seal table 41. In addition, an LM shaft and the tensioning device bridge 20b are installed above the thimble tube platform 30, to provide a forward/backward and leftward/rightward movement path of the thimble tube tensioning device 20.

As apparent from the above description, the present invention provides a handling system for an in-core detector thimble tube of a reactor, which can provide a movement path of a movable detector used to measure a neutron flux within a pressurized light weight reactor. Further, the present invention has the effect of stably managing thimble tubes, which are important components in terms of safety, serving to maintain a pressure boundary of a reactor coolant system. As a result, the present invention can achieve several advantages including an extended thimble tube exchange interval, improved safety of system facilities, reduced labor costs and working time, and reduced worker radiation exposure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A handling system for an in-core detector thimble tube of a reactor, which provides a movement path of a movable detector used to measure a neutron flux within the reactor, the handling system comprising:
a withdrawing/retracting device to grip the thimble tube using synthetic resin pinch rollers so as to withdraw and retract the thimble tube without any damage to the thimble tube;
a thimble tube tensioning device to apply a constant tensile force to the thimble tube so as to prevent the thimble tube from shaking or bending upon withdrawing/retracting operations of the thimble tube; and
a platform to temporarily keep the withdrawn thimble tube at a fixed position, to prevent shaking of the thimble tube, and to provide a movement path of the thimble tube tensioning device.

2. The handling system according to claim 1, wherein the withdrawing/retracting device includes:
a body frame;
a seal table disposed below the body frame and used to support the withdrawing/retracting device mounted thereon;
a T-shaped clamp to mount the withdrawing/retracting device on the seal table;
two upper and lower driving compression pinch rollers to be driven by two motors for increasing a thimble tube withdrawing/retracting force;
two upper and lower idle compression pinch rollers to be driven by rotation of the driving compression pinch rollers; and
a thimble tube clamping mechanism to grip the thimble tube in a roller compression manner via operation as screw nuts having clockwise and counterclockwise threads are tightened by a manually operable rotating handle.

3. The handling system according to claim 2, further comprising:
encoders provided, respectively, above the drive compression pinch rollers and the idle compression pinch rollers and used to measure an accurate withdrawn/retracted distance of the thimble tube.

4. The handling system according to claim 3, further comprising:
an O-ring clamp to prevent introduction of impurities during thimble tube withdrawing/retracting operations and simultaneously, to achieve low-pressure sealing for maintaining a pressure boundary of the reactor.

5. The handling system according to claim 4, wherein the thimble tube tensioning device performs transmission of the tensile force to the thimble tube via torque control of a DC motor.

6. The handling system according to claim 5, wherein the thimble tube tensioning device further includes a tensioning device bridge to freely displace a position of the thimble tube tensioning device according to a coordinate of the thimble tube.
